(19) United States
(12) Patent Application Publication
(10) Pub. No.: US 2024/0084929 A1
(43) Pub. Date: Mar. 14, 2024

(54) CABLE HOLDING DEVICE

(71) Applicant: Joe Davis, Eutawville, SC (US)

(72) Inventor: Joe Davis, Eutawville, SC (US)

(21) Appl. No.: 17/943,936

(22) Filed: Sep. 13, 2022

(51) Int. Cl. F16L 3/137; F16L 3/14

(52) U.S. Cl. CPC F16L 3/137; F16L 3/14

(57) ABSTRACT

A cable holding device includes a flexible panel elongated between a top edge and a bottom edge. A medial section of a cable strap is coupled to the panel such that each of a pair of opposed ends is extended from the panel. The cable strap is securable into a loop to secure a cable to the panel. A loophole is positioned at the top edge of the panel for is engaging the panel to a structure such that the panel hangs down from the structure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cable holding device and more particularly pertains to a new cable holding device for securing cables in an elevated position in a work site to prevent tripping hazards or damage to the cables.

### (2) Description of Related Art Including Information Disclosed Under 37 CFR 1.97 and 1.98

The prior art relates to cable holding devices. Known prior art devices lack flexibility to secure to different types of structures while securely engaging one or more cables, lines, wires, hoses, or the like.

### BRIEF SUMMARY OF THE INVENTION

An embodiment of the disclosure meets the needs presented above by generally comprising a flexible panel elongated between a top edge and a bottom edge. A medial section of a cable strap is coupled to the panel such that each of a pair of opposed ends is extended from the panel. The cable strap is securable into a loop to secure a cable to the panel. A loophole is positioned at the top edge of the panel for is engaging the panel to a structure such that the panel hangs down from the structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a cable holding device according to an embodiment of the disclosure.

FIG. 2 is a front view of an embodiment of the disclosure.

FIG. 3 is a front view of an embodiment of the disclosure.

FIG. 4 is a rear view of an embodiment of the disclosure.

FIG. 5 is a front view of an embodiment of the disclosure.

FIG. 6 is a top front side perspective view of an embodiment of the disclosure.

### DETAILED DESCRIPTION OF THE INVENTION

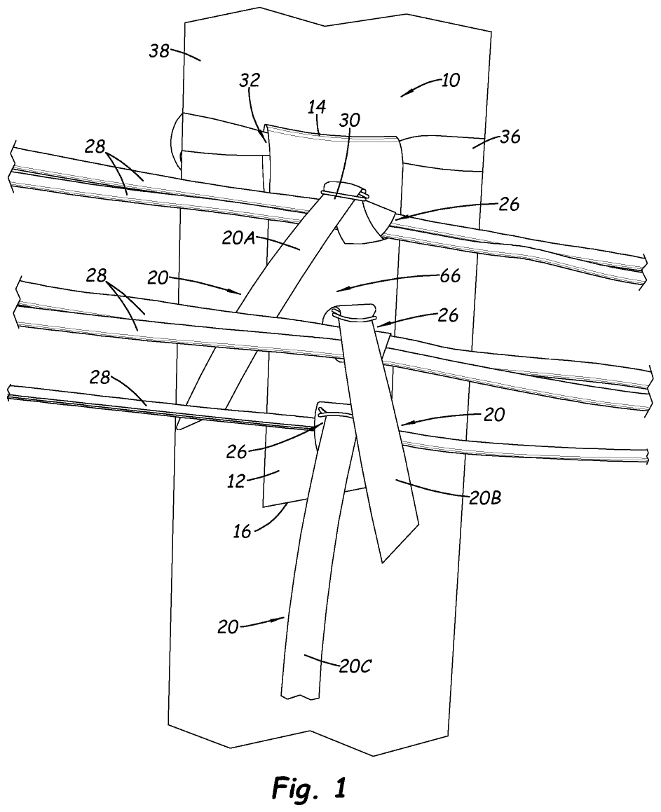

With reference now to the drawings, and in particular to FIGS. 1 through 6 thereof, a new cable holding device embodying the principles and concepts of an embodiment of the disclosure and generally designated by the reference numeral 10 will be described.

As best illustrated in FIGS. 1 through 6, the cable holding device 10 generally comprises a panel 12 having a top edge 14 and a bottom edge 16. The panel 12 is flexible. The panel 12 is elongated between the top edge 14 and the bottom edge 16. The panel 12 may be constructed of nylon, polyester, polypropylene, or other conventional strap material either natural or synthetic. The panel 12 may be elastic or non-elastic.

Each of a plurality of cable straps 20 is coupled to the panel 12. Each cable strap 20 includes a pair of opposed ends 22 and a medial section 24 extending between the opposed ends 22. The medial section 24 of each cable strap 20 is coupled to the panel 12 adjacent to a first one 22A of the opposed ends 22. The medial section 24 is coupled to the panel 12 such that each of the opposed ends 22 is extended from the panel 12. Each cable strap 20 is securable into a loop 26 wherein each cable strap 20 is configured to secure a cable 28 to the panel 12. The cable 28 may be an electrical cord from an individual tool, a power cord from a generator or other power source, or any elongated flexible line, wire, hose, or the like. The plurality of cable straps 20 includes a first cable strap 20A, a second cable strap 20B, and a third cable strap 20C. Each cable strap 20 may be positioned closer to the bottom edge 16 of the panel 12 than the top edge 14 of the panel 12. Each of a plurality of rings 30 is coupled to the first one 22A of the opposed ends 22 of a respective one of the cable straps 20 such that a second one 22B of the opposed ends 22 of the respective one of the cable straps 20 is insertable through the ring 30 to form the loop 26. Alternatively, the length of each cable strap 20 extending from the panel 12 may be of sufficient length to tie the opposed ends 22 together to form the loop 26 around the cable 28.

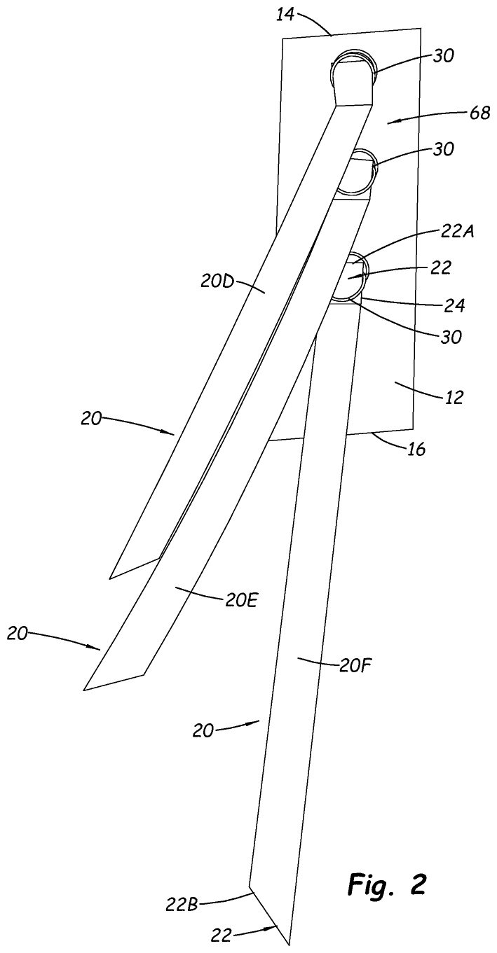

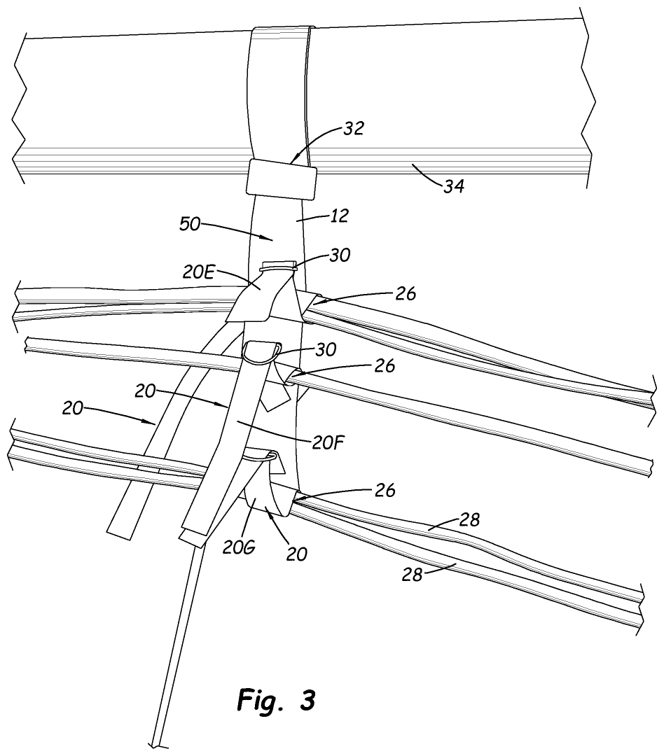

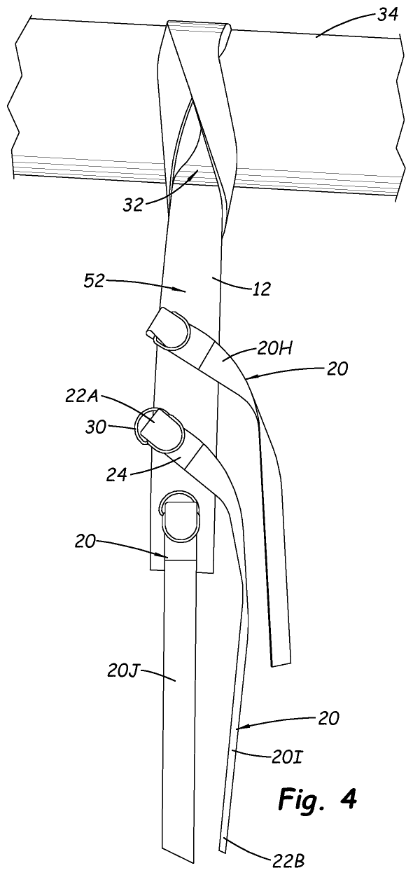

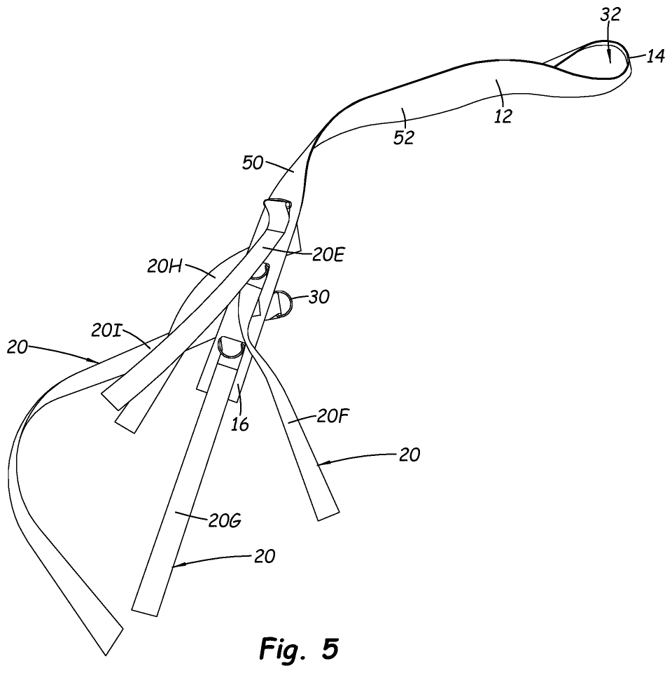

In the embodiment shown in FIGS. 1, 2, 5, and 6, there may be the three cable straps 20A, 20B, and 20C positioned on a front face 66 and one cable strap 20D positioned on rear face 68. In the embodiment shown in FIGS. 3 and 4, three spaced cable straps 20 are positioned on each of a front face 50 and rear face 52 of the panel 12. As seen in FIG. 3, three spaced cable straps 20E, 20F, and 20G may be coupled to front face 50. As seen in FIG. 4, two spaced cable straps 20H and 20I may be positioned on the rear face 52 and angled relative to a longitudinal axis of the panel 12. A third cable strap 20J may be positioned on the rear face 52 spaced from cable straps 20H and 20I, and further oriented to extend parallel to the longitudinal axis of the panel 12. As seen by comparison of FIGS. 1 and 2, or in FIG. 5, the cable straps 20 may be arranged to be spaced staggered between front faces 66,50 and rear faces 68,52 respectively.

A loophole 32 is positioned at the top edge 14 of the panel 12 wherein the panel 12 is extendable through the loophole 32. Thus, the panel 12 may be configured for being engaged to a structure 34, such as a horizontally oriented beam, pipe, or the like, such that the panel 12 hangs down from the structure 34 as shown in FIGS. 3 and 4. Alternatively, a connection strap 36 is extendable through the loophole 32 wherein the panel 12 is configured for being secured to a vertical member 38 by the connection strap 36 as shown in FIGS. 1 and 2. The connection strap 36 may be constructed of a material similar to that of the panel 12. The connection strap 36 may be a ratchet strap including a ratchet mechanism 40 for tightening the connection strap 36 to the vertical member 38.

Although not be specifically shown, one of ordinary skill in the art would understand and appreciate that elements of the configurations which are shown, and are not mutually exclusive, can be combined or interchanged to provide additional configurations of the invention.

In use, the panel 12 is attached to the structure 34 by extending the panel 12 around the structure 34 and through the loophole 32, or by threading the connection strap 36 around the vertical member 38 and through the loophole 32. The connection strap 36 may also be used for connection to any other suitable physical element if so desired. One or more cables 28 may be secured to the panel 12 using the cable straps 20. The cables 28 may be attached separately and individually or in groups. Thus, the device 10 can be used to organize and support cables 28 in an elevated position where they are not subject to being stepped upon, tripping persons, or being damaged by contact with tools and materials around a work site or the like.

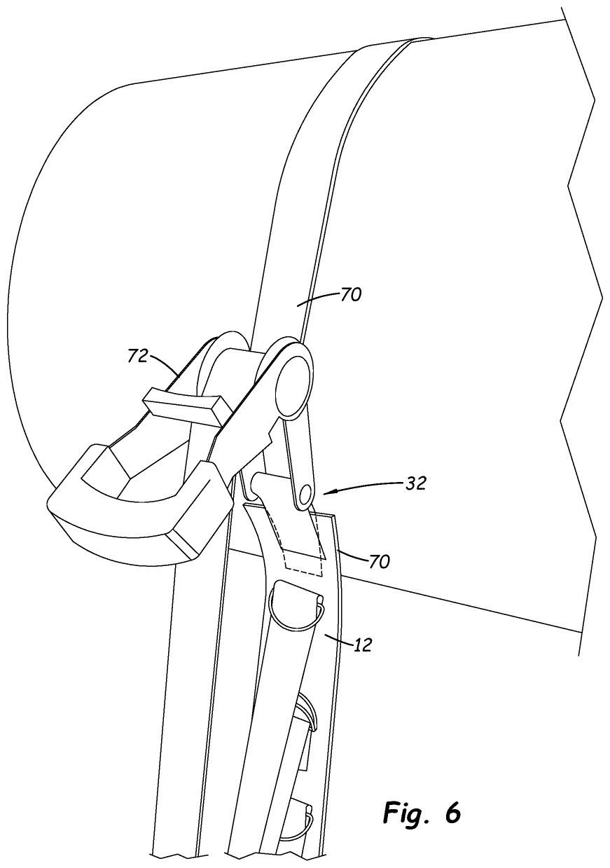

In an embodiment shown in FIG. 6, the loophole 32 is formed by overlapping of a ratchet strap 70 attached to the top end 14 of the panel 12. A ratchet 72 is attached to the loophole 32 formed by the ratchet strap 70. The ratchet strap 70 further extends away from the panel 12 such that the ratchet strap 70 can be extended around the structure 34 allowing the ratchet strap 70 to be tightened securing the panel 12 to the structure 34.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A cable holding device comprising:
a panel having a top edge and a bottom edge, said panel being flexible, said panel being elongated between said top edge and said bottom edge;
a cable strap having pair of opposed ends and a medial section extending between said opposed ends, said medial section being coupled to said panel such that each of said opposed ends is extended from said panel, said cable strap being securable into a loop wherein said cable strap is configured to secure a cable to said panel, said medial section of said cable strap being coupled to said panel adjacent to a first one of said opposed ends;
a ring coupled to said first one of said opposed ends of said cable strap wherein a second one of said opposed ends is insertable through said ring to form said loop, wherein a size of said loop is adjustable; and
a loophole positioned at said top edge of said panel wherein said panel is extendable through said loophole whereby said panel is configured for being engaged to a structure such that said panel hangs down from the structure.

2. The cable holding device of claim 1, further comprising a connection strap, said connection strap being extendable through said loophole wherein said panel is configured for being secured to a vertical member by said connection strap.

3. The cable holding device of claim 1, further comprising said cable strap being one cable strap of a plurality of cable straps.

4. The cable holding device of claim 1, further comprising:
said cable strap being a first cable strap; and
a second cable strap.

5. The cable holding device of claim 4, further comprising a third cable strap, said first cable strap, said second cable strap, and said third cable strap being spaced apart along a longitudinal axis of said panel such that each of said first cable strap, said second cable strap, and said third cable strap are securable into respective loops configured to engage and support respective cables extending across said panel.

6. The cable holding device of claim 5, further comprising each of said first cable strap, said second cable strap, and said third cable strap being positioned closer to said bottom edge of said panel than said top edge of said panel.

7. (canceled)

8. A cable holding device comprising:
a panel having a top edge and a bottom edge, said panel being flexible, said panel being elongated between said top edge and said bottom edge;
a plurality of cable straps, each cable strap comprising:
a pair of opposed ends and a medial section extending between said opposed ends, said medial section of said cable strap being coupled to said panel adjacent to a first one of said opposed ends, said medial section being coupled to said panel such that each of said opposed ends is extended from said panel, each cable strap being securable into a loop wherein each cable strap is configured to secure a cable to said panel, said plurality of cable straps including a first cable strap, a second cable strap, and a third cable strap, each cable strap being positioned closer to said bottom edge of said panel than said top edge of said panel;
a plurality of rings, each said ring being coupled to said first one of said opposed ends of a respective one of said cable straps wherein a second one of said opposed ends of said respective one of said cable straps is insertable through said ring to form said loop, wherein a size of each said loop is adjustable;
a loophole positioned at said top edge of said panel wherein said panel is extendable through said loophole whereby said panel is configured for being engaged to a structure such that said panel hangs down from the structure; and
a connection strap, said connection strap being extendable through said loophole wherein said panel is configured for being secured to a vertical member by said connection strap.
